(19) United States
(12) Patent Application Publication
(10) Pub. No.: US 2024/0372097 A1
(43) Pub. Date: Nov. 7, 2024

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventors: Nobuhiro INOUE, Kyoto (JP); Mitsunori NAKAMOTO, Kyoto (JP)

(21) Appl. No.: 18/773,987

(22) Filed: Jul. 16, 2024

Related U.S. Application Data
(63) Continuation of application No. PCT/JP2023/005461, filed on Feb. 16, 2023.

(30) Foreign Application Priority Data
Mar. 16, 2022 (JP) 2022-041361

(51) Int. Cl. H01M 4/583; H01M 4/02; H01M 4/133; H01M 4/134; H01M 4/38; H01M 4/62; H01M 10/0525

(52) U.S. Cl. CPC H01M 4/583; H01M 4/133; H01M 4/134; H01M 4/386; H01M 4/62; H01M 10/0525; H01M 2004/027

(57) ABSTRACT

A secondary battery includes a positive electrode, a negative electrode, and an electrolytic solution. The negative electrode includes a negative electrode active material layer. The negative electrode active material layer includes a negative electrode active material, lithium fluoride (LiF), and lithium ethylene dicarbonate (Li—OC(═O)O—C₂H₄—OC(═O)O—Li). A weight ratio represented by Expression (1) is greater than or equal to 0.01 and less than or equal to 0.2. A weight sum represented by Expression (2) is greater than or equal to 0.2 wt % and less than or equal to 2.0 wt %.

$$MA = M 2 / M 1 \qquad ( 1 )$$

where:
MA is the weight ratio;
M1 is a ratio (wt %) of a weight of lithium fluoride to a weight of the negative electrode active material; and
M2 is a ratio (wt %) of a weight of lithium ethylene dicarbonate to the weight of the negative electrode active material.

$$MB = M 1 + M 2 \qquad ( 2 )$$

where:
MB is the weight sum (wt %);
M1 is the ratio (wt %) of the weight of lithium fluoride to the weight of the negative electrode active material; and
M2 is the ratio (wt %) of the weight of lithium ethylene dicarbonate to the weight of the negative electrode active material.

### CROSS REFERENCE TO RELATED APPLICATIONS

The present application is a continuation of PCT patent application no. PCT/JP2023/005461, filed on Feb. 16, 2023, which claims priority to Japanese patent application no. 2022-041361, filed on Mar. 16, 2022, the entire contents of which are incorporated herein by reference.

### BACKGROUND

The present technology relates to a negative electrode for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode (a negative electrode for a secondary battery), and an electrolytic solution. A configuration of the secondary battery has been considered in various ways.

For example, in a surface-modified carbonaceous particulate material including carbonaceous core particles, the carbonaceous core particles have a hydrophilic non-graphitic carbon coating. In addition, an electrolytic solution includes a lithium salt additive, and the lithium salt additive includes, for example, lithium fluoride.

### SUMMARY

The present technology relates to a negative electrode for a secondary battery, and a secondary battery.

Although consideration has been given in various ways regarding a configuration of a secondary battery, a battery characteristic of the secondary battery is not sufficient yet. Accordingly, there is room for improvement in terms thereof.

It is desirable to provide a negative electrode for a secondary battery, and a secondary battery that each make it possible to achieve a superior battery characteristic.

A negative electrode for a secondary battery according to an embodiment of the present technology includes a negative electrode active material layer. The negative electrode active material layer includes a negative electrode active material, lithium fluoride (LiF), and lithium ethylene dicarbonate (Li—OC(═O)O—C₂H₄—OC(═O)O—Li). A weight ratio represented by Expression (1) is greater than or equal to 0.01 and less than or equal to 0.2. A weight sum represented by Expression (2) is greater than or equal to 0.2 wt % and less than or equal to 2.0 wt %.

$$MA = M 2 / M 1 \qquad ( 1 )$$

where:
MA is the weight ratio;
M1 is a ratio (wt %) of a weight of lithium fluoride to a weight of the negative electrode active material; and
M2 is a ratio (wt %) of a weight of lithium ethylene dicarbonate to the weight of the negative electrode active material.

$$MB = M 1 + M 2 \qquad ( 2 )$$

where:
MB is the weight sum (wt %);
M1 is the ratio (wt %) of the weight of lithium fluoride to the weight of the negative electrode active material; and
M2 is the ratio (wt %) of the weight of lithium ethylene dicarbonate to the weight of the negative electrode active material.

A secondary battery according to an embodiment of the present technology includes a positive electrode, a negative electrode, and an electrolytic solution. The negative electrode has a configuration similar to the configuration of the negative electrode for a secondary battery according to the embodiment of the present technology described above.

According to the negative electrode for a secondary battery or the secondary battery of an embodiment of the present technology, the negative electrode active material layer of the negative electrode for a secondary battery includes the negative electrode active material, lithium fluoride, and lithium ethylene dicarbonate; the weight ratio represented by Expression (1) is greater than or equal to 0.01 and less than or equal to 0.2; and the weight sum represented by Expression (2) is greater than or equal to 0.2 wt % and less than or equal to 2.0 wt %. Accordingly, it is possible to achieve a superior battery characteristic.

Note that effects of the present technology are not necessarily limited to those described herein and may include any of a series of effects described below in relation to the present technology.

### BRIEF DESCRIPTION OF THE FIGURES

FIG. 1 is a sectional diagram illustrating a configuration of a negative electrode for a secondary battery according to an embodiment of the present technology.

FIG. 2 is a perspective diagram illustrating a configuration of a secondary battery according to an embodiment of the present technology.

FIG. 3 is a sectional diagram illustrating a configuration of a battery device illustrated in FIG. 2.

FIG. 4 is a plan diagram illustrating a configuration of a positive electrode illustrated in FIG. 3.

FIG. 5 is a plan diagram illustrating a configuration of a negative electrode illustrated in FIG. 3.

FIG. 6 is a perspective diagram for describing a method of manufacturing the secondary battery.

FIG. 7 is a block diagram illustrating a configuration of an application example of the secondary battery.

### DETAILED DESCRIPTION

The present technology is described below in further detail including with reference to the drawings according to an embodiment.

A description is given first of a negative electrode for a secondary battery (hereinafter, simply referred to as a “negative electrode”) according to an embodiment of the present technology.

The negative electrode to be described here is to be used in a secondary battery, which is an electrochemical device. However, the negative electrode may be used in electrochemical devices other than a secondary battery. Specific examples of the other electrochemical devices include a capacitor.

An electrode reactant is to be inserted into and extracted from the negative electrode upon an electrode reaction of the electrochemical device. The electrode reactant is not particularly limited in kind, and specific examples thereof include a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. That is, lithium is inserted into and extracted from the negative electrode in an ionic state upon the electrode reaction.

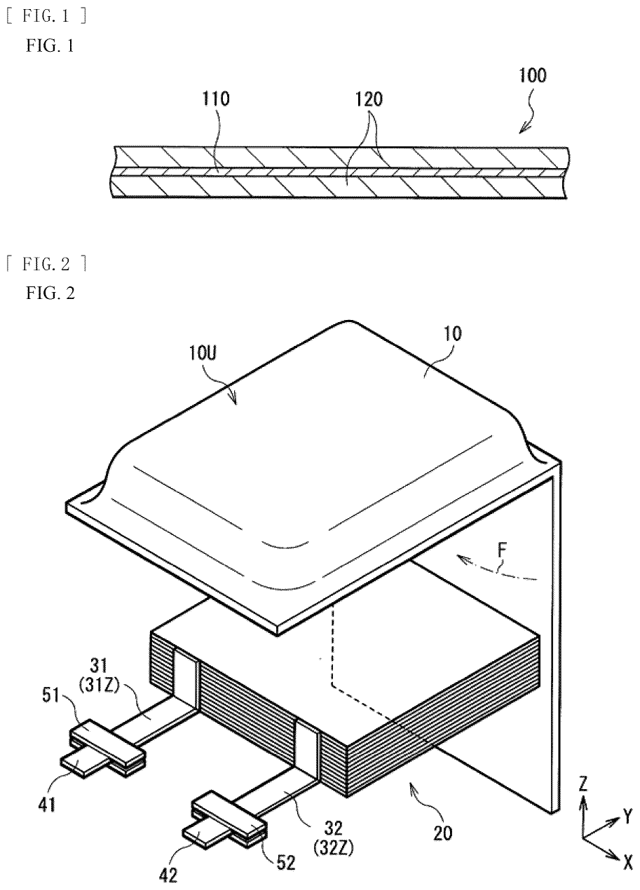

FIG. 1 illustrates a sectional configuration of a negative electrode 100 as an example of the negative electrode. Note that FIG. 1 illustrates only a portion of the negative electrode 100.

As illustrated in FIG. 1, the negative electrode 100 includes a negative electrode active material layer 120. Here, the negative electrode 100 further includes a negative electrode current collector 110 that supports the negative electrode active material layer 120.

The negative electrode current collector 110 is an electrically conductive support that supports the negative electrode active material layer 120. The negative electrode current collector 110 has two opposed surfaces on each of which the negative electrode active material layer 120 is to be provided. The negative electrode current collector 110 includes any one or more of electrically conductive materials including, without limitation, a metal material. Specific examples of the electrically conductive material include copper.

A surface of the negative electrode current collector 110 is preferably roughened by a method such as an electrolytic method. A reason for this is that adherence of the negative electrode active material layer 120 to the negative electrode current collector 110 is improved using what is called an anchor effect.

Note, however, that the negative electrode current collector 110 may be omitted. That is, the negative electrode 100 may include only the negative electrode active material layer 120.

The negative electrode active material layer 120 includes a negative electrode active material which lithium is insertable into and extractable from, lithium fluoride, and lithium ethylene dicarbonate. Note that the negative electrode active material layer 120 may further include any one or more of other materials including, without limitation, a negative electrode binder and a negative electrode conductor.

Here, the negative electrode active material layer 120 is provided on each of the two opposed surfaces of the negative electrode current collector 110. Note, however, that the negative electrode active material layer 120 may be provided only on one of the two opposed surfaces of the negative electrode current collector 110.

A method of forming the negative electrode active material layer 120 is not particularly limited and specifically includes any one or more of methods including, without limitation, a coating method, a vapor-phase method, a liquid-phase method, a thermal spraying method, and a firing (sintering) method.

The negative electrode active material is not particularly limited in kind and specifically includes any one or more of materials including, without limitation, a carbon material and a metal-based material. That is, the negative electrode active material may include only the carbon material, only the metal-based material, or both of the carbon material and the metal-based material. A reason for this is that a high energy density is obtainable. However, the kind of the negative electrode active material may be any material other than the carbon material and the metal-based material.

The term “carbon material” is a generic term for a material including carbon as a constituent element. A high energy density is stably obtainable owing to a crystal structure of the carbon material that hardly varies upon insertion and extraction of lithium. In addition, improved electrical conductivity of the negative electrode active material layer 120 is achievable owing to the carbon material that also serves as the negative electrode conductor.

Specific examples of the carbon material include graphitizable carbon, non-graphitizable carbon, and graphite. The graphite may include natural graphite, artificial graphite, or both. Spacing of a (002) plane of the non-graphitizable carbon is not particularly limited and is specifically greater than or equal to 0.37 nm. Spacing of a (002) plane of the graphite is not particularly limited and is specifically less than or equal to 0.34 nm.

Specific examples of the carbon material also include pyrolytic carbons, cokes, glassy carbon fibers, an organic polymer compound fired body, activated carbon, and carbon blacks. Examples of the cokes include pitch coke, needle coke, and petroleum coke. The organic polymer compound fired body is a fired material resulting from firing or carbonizing a polymer compound such as a phenol resin or a furan resin at an appropriate temperature. Other than the above, the carbon material may be low-crystalline carbon subjected to heat treatment at a temperature of about 1000° C. or lower, or may be amorphous carbon. The carbon material is not particularly limited in shape, and specific examples thereof include any one or more of shapes including, without limitation, a fibrous shape, a spherical shape, a granular shape, and a flaky shape.

The term “metal-based material” is a generic term for a material that includes, as one or more constituent elements, any one or more elements among metal elements and metalloid elements that are each able to form an alloy with lithium. A higher energy density is obtainable owing to the metal-based material.

The metal-based material may be a simple substance, an alloy, a compound, a mixture of two or more thereof, or a material including one or more phases thereof. The “simple substance” described here merely refers to a simple substance in a general sense. The simple substance may therefore include a small amount of impurity. That is, purity of the simple substance does not necessarily have to be 100%.

Note, however, that the “alloy” described here includes not only a material including two or more metal elements as constituent elements, but also a material including one or more metal elements and one or more metalloid elements as constituent elements. The “alloy” may further include one or more non-metallic elements as one or more constituent elements. The metal-based material is not particularly limited in state, but specifically includes any one or more states including, without limitation, a solid solution, a eutectic (a eutectic mixture), an intermetallic compound, and a state including two or more thereof that coexist.

Specific examples of the metal element and the metalloid element include magnesium, boron, aluminum, gallium, indium, silicon, germanium, tin, lead, bismuth, cadmium, silver, zinc, hafnium, zirconium, yttrium, palladium, and platinum.

In particular, the metal-based material is preferably a silicon-containing material. A reason for this is that a markedly high energy density is obtainable owing to superior lithium insertability and superior lithium extractability of the silicon-containing material. The term “silicon-containing material” is a generic term for a material that includes silicon as a constituent element. That is, the silicon-containing material may be a simple substance of silicon, a silicon alloy, a silicon compound, a mixture of two or more thereof, or a material including one or more phases thereof.

The silicon alloy includes any one or more of metal elements including, without limitation, tin, nickel, copper, iron, cobalt, manganese, zinc, indium, silver, titanium, germanium, bismuth, antimony, and chromium as one or more constituent elements other than silicon. The silicon compound includes any one or more of non-metallic elements including, without limitation, carbon and oxygen as one or more constituent elements other than silicon. Note, however, that the silicon compound may further include, as one or more constituent elements other than silicon, any one or more of the series of metal elements described in relation to the silicon alloy.

Specific examples of the silicon alloy include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, and SiC. Note, however, that a composition of the silicon alloy (a mixture ratio between silicon and the metal element) may be changed as desired.

Specific examples of the silicon compound include Si₃N₄, Si₂N₂O, SiOₓ (where 0<x≤2), and LiSiO. Note, however, that a range of “x” may be 0.2<x<1.4.

Based upon the above, the negative electrode active material preferably includes the silicon-containing material as the metal-based material. A reason for this is that a markedly high energy density is obtainable as described above.

In this case, the negative electrode active material preferably further includes the carbon material. That is, the negative electrode active material preferably includes both the carbon material and the silicon-containing material. A reason for this is that this prevents, for example, damage to and detachment of the negative electrode active material layer 120, while securing a battery capacity, upon an electrode reaction (charging and discharging) of a secondary battery including the negative electrode 100.

In detail, while the silicon-containing material as the metal-based material has an advantage of having a high theoretical capacity, there is a concern that the silicon-containing material easily expands and contracts greatly upon charging and discharging. While there is a concern that the carbon material has a low theoretical capacity, the carbon material has an advantage of resisting expanding and contracting upon charging and discharging. Thus, the combined use of the carbon material and the silicon-containing material suppresses expanding and contracting of the negative electrode active material layer 120 upon charging and discharging while achieving a high theoretical capacity. This prevents, for example, damage to and detachment of the negative electrode active material layer 120, while securing the battery capacity, as described above.

Lithium fluoride and lithium ethylene dicarbonate are included in the negative electrode active material layer 120 as described above. Thus, the negative electrode active material, lithium fluoride, and lithium ethylene dicarbonate are mixed with each other and each dispersed in the negative electrode active material layer 120.

Lithium ethylene dicarbonate decomposes and reacts upon the electrode reaction to thereby form a protective film on a surface of the negative electrode active material. Thus, the surface of the negative electrode active material having reactivity is protected by the protective film, which suppresses a decomposition reaction of an electrolytic solution on the surface of the negative electrode active material upon charging and discharging of the secondary battery including the negative electrode 100. In the following, a function of protecting the surface of the negative electrode active material by using a film derived from lithium ethylene dicarbonate is referred to as a “protective function of lithium ethylene dicarbonate”.

Lithium fluoride is caused to decompose and react preferentially over lithium ethylene dicarbonate upon the electrode reaction, to thereby suppress decomposition of lithium ethylene dicarbonate without forming of the protective film. In other words, lithium fluoride works self-sacrificially upon the electrode reaction to thereby suppress loss of the protective function of lithium ethylene dicarbonate.

Note that respective predetermined conditions are satisfied regarding a mixture ratio between lithium fluoride and lithium ethylene dicarbonate and a mixture amount of lithium fluoride and lithium ethylene dicarbonate, in order to secure the protective function of lithium ethylene dicarbonate.

Specifically, a weight ratio MA represented by Expression (1) is within a range from 0.01 to 0.2 both inclusive, and a weight sum MB represented by Expression (2) is within a range from 0.2 wt % to 2.0 wt % both inclusive.

$$MA = M 2 / M 1 \qquad ( 1 )$$

where:
MA is the weight ratio;
M1 is a ratio (wt %) of a weight of lithium fluoride to a weight of the negative electrode active material; and
M2 is a ratio (wt %) of a weight of lithium ethylene dicarbonate to the weight of the negative electrode active material.

$$MB = M 1 + M 2 \qquad ( 2 )$$

where:
MB is the weight sum (wt %);
M1 is the ratio (wt %) of the weight of lithium fluoride to the weight of the negative electrode active material; and
M2 is the ratio (wt %) of the weight of lithium ethylene dicarbonate to the weight of the negative electrode active material.

As is apparent from Expression (1), the weight ratio MA is a parameter representing the mixture ratio between lithium fluoride and lithium ethylene dicarbonate, and is calculated based on the ratio M1 of lithium fluoride and the ratio M2 of lithium ethylene dicarbonate.

As is apparent from Expression (2), the weight sum MB is a parameter representing the mixture amount of lithium fluoride and lithium ethylene dicarbonate, and is calculated based on the ratios M1 and M2 as with the weight ratio MA.

A reason why the negative electrode active material layer 120 includes lithium fluoride and lithium ethylene dicarbonate and the respective conditions described above are satisfied regarding the weight ratio MA and the weight sum MB is that the mixture ratio between lithium fluoride and lithium ethylene dicarbonate and the mixture amount of lithium fluoride and lithium ethylene dicarbonate are each made appropriate. This secures the protective function of lithium ethylene dicarbonate, while suppressing a decrease in the electrical conductivity of the negative electrode active material layer 120 due to the presence of lithium fluoride and lithium ethylene dicarbonate.

Note that the ratio M1 is adjustable to a desired value by changing respective amounts of the negative electrode active material and lithium fluoride in a manufacturing process of the negative electrode 100 to be described later. The ratio M2 is adjustable to a desired value by changing respective amounts of the negative electrode active material and lithium ethylene dicarbonate in the manufacturing process of the negative electrode 100. Thus, changing each of the ratios M1 and M2 makes it possible to adjust each of the weight ratio MA and the weight sum MB.

A procedure for calculating the ratio M1 is as described below. In the following, described is a case where the negative electrode active material layer 120 includes the negative electrode binder together with the negative electrode active material, lithium fluoride, and lithium ethylene dicarbonate.

First, in the negative electrode 100, the negative electrode current collector 110 is peeled off from the negative electrode active material layer 120 to thereby collect the negative electrode active material layer 120. In a case of using the secondary battery including the negative electrode 100, the secondary battery is disassembled to thereby collect the negative electrode 100.

Thereafter, the negative electrode active material layer 120 is put into a solvent for dissolution and removal, following which the solvent is stirred. The solvent includes any one or more of solvents that are able to dissolve lithium fluoride, lithium ethylene dicarbonate, and the negative electrode binder, and is specifically an aqueous solvent such as water. Thus, lithium fluoride, lithium ethylene dicarbonate, and the negative electrode binder are dissolved by the solvent, whereas the negative electrode active material is not dissolved by the solvent. As a result, the negative electrode active material is separated from lithium fluoride, lithium ethylene dicarbonate, and the negative electrode binder in the solvent.

Thereafter, the solvent is filtered to thereby collect the negative electrode active material, following which a weight G1 of the negative electrode active material is measured.

Meanwhile, the negative electrode 100 is washed with a solvent for washing, following which the negative electrode 100 is dried. The solvent includes any one or more of organic solvents, and is specifically acetone, for example. An environment at the time of drying may be an inert gas atmosphere including argon gas, for example, or may be a dry environment.

Thereafter, the negative electrode 100 is put into a solution for extraction to thereby perform an extraction process (for an extraction time of 15 minutes). Used as the solution is a dimethyl sulfoxide-d₆ solution (LiTFSI DMSO-d₆) of lithium bis(trifluoromethanesulfonyl)imide (LiN(CF₃SO₂)₂). Thus, an extract including lithium fluoride is obtained.

Thereafter, the extract is analyzed by fluorine-19 nuclear magnetic resonance (¹⁹F NMR). Thus, a peak attributed to lithium fluoride is detected at −203 ppm. Thereafter, an integrated value of a signal is compared with an integrated value of a signal of an internal standard substance to thereby identify a weight G2 of lithium fluoride included in the extract. Used as the internal standard substance is sodium 3-(trimethylsilyl) propionate-d₄.

Lastly, the ratio M1 (=G2/G1) is calculated based on the weights G1 and G2.

A procedure for calculating the ratio M2 is similar to the procedure for calculating the ratio M1 except that an analysis method is changed.

In a case of analyzing the extract, the extract is analyzed by proton nuclear magnetic resonance (¹H NMR) and carbon-13 nuclear magnetic resonance (¹³C NMR). Thus, a peak attributed to lithium ethylene dicarbonate is detected at 3.63 ppm when the proton nuclear magnetic resonance is used. In addition, a peak attributed to lithium ethylene dicarbonate is detected at each of 62.7 ppm and 166.2 ppm when the carbon-13 nuclear magnetic resonance is used. Thus, a weight G3 of lithium ethylene dicarbonate included in the extract is identified, and the ratio M2 (=G3/G1) is calculated based on the weights G1 and G3.

The weight ratio MA (=M2/M1) is calculated and the weight sum MB (=M1+M2) is calculated, based on results of the calculation of the ratios M1 and M2 described above.

The negative electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The negative electrode conductor includes any one or more of electrically conductive materials including, without limitation, a carbon material. Specific examples of the electrically conductive material include graphite, carbon black, acetylene black, and Ketjen black. Note, however, that the electrically conductive material is not limited to the carbon material, and may be a metal material or a polymer compound, for example.

In the negative electrode 100, the negative electrode active material layer 120 at the time of the electrode reaction allows lithium to be inserted into the negative electrode active material in an ionic state, and allows lithium to be extracted from the negative electrode active material in an ionic state.

In a case of manufacturing the negative electrode 100, first, the negative electrode active material, lithium fluoride, and lithium ethylene dicarbonate are mixed with each other to thereby obtain a negative electrode mixture. In this case, the amount of the negative electrode active material, the amount of lithium fluoride, and the amount of lithium ethylene dicarbonate are adjusted to satisfy the respective conditions described above regarding the weight ratio MA and the weight sum MB. Note that the negative electrode mixture may include, for example, the negative electrode binder or the negative electrode conductor on an as-needed basis.

Thereafter, the negative electrode mixture is put into a solvent to thereby prepare a negative electrode mixture slurry in paste form. The solvent is an aqueous solvent such as water. In this case, the solvent with the negative electrode mixture put thereinto may be stirred using a stirring apparatus such as a mixer.

Here, the negative electrode mixture including lithium fluoride and lithium ethylene dicarbonate is prepared, following which the negative electrode mixture slurry is prepared using the negative electrode mixture. However, a negative electrode mixture slurry may be prepared using a negative electrode mixture including neither lithium fluoride nor lithium ethylene dicarbonate, following which lithium fluoride and lithium ethylene dicarbonate may be added to the negative electrode mixture slurry.

Lastly, the negative electrode mixture slurry is applied on the two opposed surfaces of the negative electrode current collector 110 to thereby form the negative electrode active material layers 120. Thereafter, the negative electrode active material layers 120 may be compression-molded by means of, for example, a roll pressing machine. In this case, the negative electrode active material layers 120 may be heated. The negative electrode active material layers 120 may be compression-molded multiple times.

In this manner, the negative electrode active material layers 120 are formed on the respective two opposed surfaces of the negative electrode current collector 110. Thus, the negative electrode 100 is completed.

According to the negative electrode 100, the negative electrode active material layer 120 of the negative electrode 100 includes the negative electrode active material, lithium fluoride, and lithium ethylene dicarbonate; the weight ratio MA is within the range from 0.01 to 0.2 both inclusive; and the weight sum MB is within the range from 0.2 wt % to 2.0 wt % both inclusive.

In this case, as described above, the mixture ratio between lithium fluoride and lithium ethylene dicarbonate and the mixture amount of lithium fluoride and lithium ethylene dicarbonate are each made appropriate. This secures the protective function of lithium ethylene dicarbonate, while suppressing a decrease in the electrical conductivity of the negative electrode active material layer 120 due to the presence of lithium fluoride and lithium ethylene dicarbonate.

Accordingly, it is possible for the secondary battery including the negative electrode 100 to achieve a superior battery characteristic.

In particular, the negative electrode active material may include the silicon-containing material. This makes it possible to obtain a markedly high energy density. Accordingly, it is possible to achieve higher effects. In this case, the negative electrode active material may further include the carbon material. This prevents, for example, damage to and detachment of the negative electrode active material layer 120, while securing the battery capacity. Accordingly, it is possible to achieve further higher effects.

A description is given next of a secondary battery according to an embodiment of the present technology to which the negative electrode 100 is applicable.

The secondary battery to be described here is a secondary battery that obtains a battery capacity through insertion and extraction of an electrode reactant, and includes a positive electrode, a negative electrode, and an electrolytic solution.

In the secondary battery, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

Examples are given below of a case where the electrode reactant is lithium as described above. A secondary battery that obtains a battery capacity through insertion and extraction of lithium is what is called a lithium-ion secondary battery. In the lithium-ion secondary battery, lithium is inserted and extracted in an ionic state.

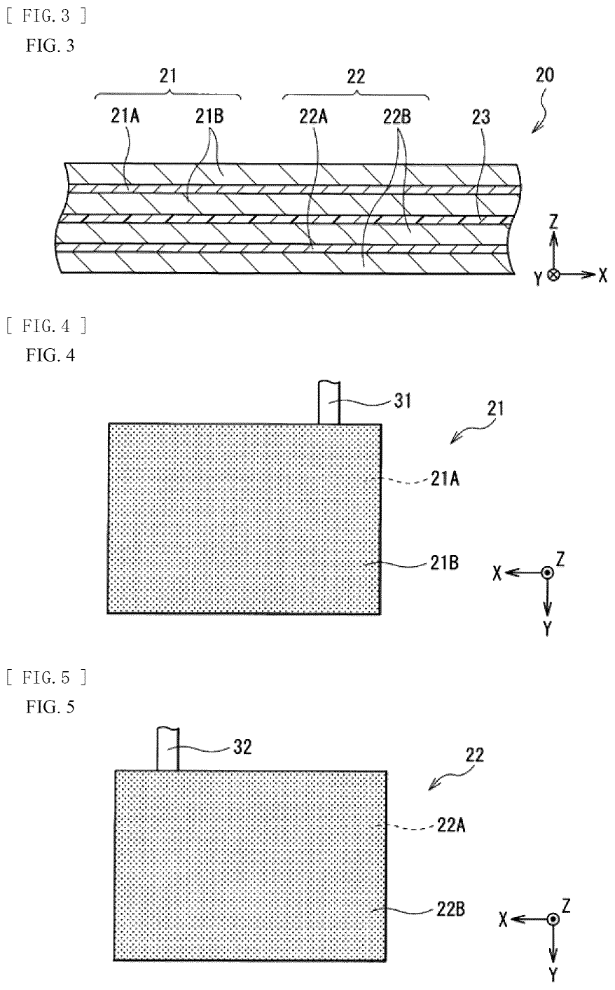

FIG. 2 illustrates a perspective configuration of the secondary battery. FIG. 3 illustrates a sectional configuration of a battery device 20 illustrated in FIG. 2. FIG. 4 illustrates a plan configuration of a positive electrode 21 illustrated in FIG. 3. FIG. 5 illustrates a plan configuration of a negative electrode 22 illustrated in FIG. 3. Note that FIG. 2 illustrates a state where an outer package film 10 and the battery device 20 are separated from each other. FIG. 3 illustrates only a portion of the battery device 20.

As illustrated in FIGS. 2 and 3, the secondary battery includes the outer package film 10, the battery device 20, multiple positive electrode terminals 31, multiple negative electrode terminals 32, a positive electrode lead 41, a negative electrode lead 42, and sealing films 51 and 52.

The secondary battery described here includes the outer package film 10 having flexibility or softness as an outer package member as described above, and is thus a secondary battery of what is called a laminated-film type.

### [Outer Package Film]

As illustrated in FIG. 2, the outer package film 10 is the outer package member that contains the battery device 20. The outer package film 10 has a pouch-shaped structure that is sealed in a state where the battery device 20 is contained inside the outer package film 10. The outer package film 10 thus contains the positive electrode 21, the negative electrode 22, and an electrolytic solution that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

As illustrated in FIGS. 2 to 5, the battery device 20 is a power generation device that includes the positive electrode 21, the negative electrode 22, a separator 23, and the electrolytic solution (not illustrated). The battery device 20 is contained inside the outer package film 10.

Here, the battery device 20 is what is called a stacked electrode body. The positive electrode 21 and the negative electrode 22 are thus alternately stacked on each other with the separator 23 interposed therebetween. The respective numbers of the positive electrode 21, the negative electrode 22, and the separator 23 are not particularly limited, and may be set as desired.

The positive electrode 21 includes, as illustrated in FIGS. 3 and 4, a positive electrode current collector 21A and a positive electrode active material layer 21B. In FIG. 4, the positive electrode active material layer 21B is shaded.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B includes any one or more of positive electrode active materials which lithium is insertable into and extractable from. Note that the positive electrode active material layer 21B may further include any one or more of other materials including, without limitation, a positive electrode binder and a positive electrode conductor.

Here, the positive electrode active material layer 21B is provided on each of the two opposed surfaces of the positive electrode current collector 21A. Note, however, that the positive electrode active material layer 21B may be provided only on one of the two opposed surfaces of the positive electrode current collector 21A on a side where the positive electrode 21 is opposed to the negative electrode 22. A method of forming the positive electrode active material layer 21B is not particularly limited, and is specifically a coating method, for example.

The positive electrode active material is not particularly limited in kind, and specific examples thereof include a lithium-containing compound. The lithium-containing compound is a compound including lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table of elements. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

Details of the positive electrode binder are similar to those of the negative electrode binder described above. Details of the positive electrode conductor are similar to those of the negative electrode conductor described above.

Here, as illustrated in FIG. 4, the positive electrode current collector 21A partly protrudes, and the positive electrode current collector 21A thus includes a part (hereinafter, referred to as a “protruding part of the positive electrode current collector 21A”) protruding toward an outer side relative to the positive electrode active material layer 21B. The positive electrode active material layer 21B is not provided on the protruding part of the positive electrode current collector 21A, and the protruding part of the positive electrode current collector 21A thus serves as the positive electrode terminal 31. Details of the positive electrode terminal 31 will be described later.

The positive electrode active material layer 21B is provided only on a portion of the positive electrode current collector 21A on each of the two opposed surfaces (excluding the positive electrode terminal 31) of the positive electrode current collector 21A. Accordingly, a part of the positive electrode current collector 21A on which the positive electrode active material layer 21B is not provided is exposed without being covered with the positive electrode active material layer 21B.

Specifically, as illustrated in FIG. 4, the positive electrode current collector 21A includes a covered part 21AX and an uncovered part 21AY. The covered part 21AX is a part that is located at the middle part of the positive electrode current collector 21A and on which the positive electrode active material layer 21B is provided. The uncovered part 21AY is a frame-shaped part that is located around the covered part 21AX and on which the positive electrode active material layer 21B is not provided. Accordingly, the covered part 21AX is covered with the positive electrode active material layer 21B, whereas the uncovered part 21AY is exposed without being covered with the positive electrode active material layer 21B.

The negative electrode 22 has a configuration similar to that of the negative electrode 100. Specifically, the negative electrode 22 includes, as illustrated in FIGS. 3 and 5, a negative electrode current collector 22A and a negative electrode active material layer 22B. In FIG. 5, the negative electrode active material layer 22B is shaded.

The negative electrode current collector 22A has a configuration similar to that of the negative electrode current collector 110. The negative electrode active material layer 22B has a configuration similar to that of the negative electrode active material layer 120. That is, the negative electrode active material layer 22B includes the negative electrode active material, lithium fluoride, and lithium ethylene carbonate, and the respective conditions described above are satisfied regarding the weight ratio MA and the weight sum MB.

Here, as illustrated in FIG. 5, the negative electrode current collector 22A partly protrudes, and the negative electrode current collector 22A thus includes a part (hereinafter, referred to as a “protruding part of the negative electrode current collector 22A”) protruding toward the outer side relative to the negative electrode active material layer 22B.

A direction in which the protruding part of the negative electrode current collector 22A protrudes is similar to the direction in which the protruding part of the positive electrode current collector 21A protrudes. In addition, a position of the protruding part of the negative electrode current collector 22A is a position that does not overlap the protruding part of the positive electrode current collector 21A in a state where the positive electrode 21 and the negative electrode 22 are alternately stacked on each other with the separator 23 interposed therebetween.

The negative electrode active material layer 22B is not provided on the protruding part of the negative electrode current collector 22A, and the protruding part of the negative electrode current collector 22A thus serves as the negative electrode terminal 32. Details of the negative electrode terminal 32 will be described later.

The negative electrode active material layer 22B is provided on the entire negative electrode current collector 22A on each of the two opposed surfaces (excluding the negative electrode terminal 32) of the negative electrode current collector 22A. Accordingly, the negative electrode current collector 22A is entirely covered with the negative electrode active material layer 22B without being exposed.

Specifically, as illustrated in FIG. 5, the negative electrode active material layer 22B includes an opposed part 22BX and a non-opposed part 22BY. The opposed part 22BX is opposed to the covered part 21AX. That is, the opposed part 22BX is opposed to the positive electrode active material layer 21B and thus contributes to charging and discharging reactions. The non-opposed part 22BY is opposed to the uncovered part 21AY. That is, the non-opposed part 22BY is opposed to the positive electrode current collector 21A without being opposed to the positive electrode active material layer 21B and thus does not contribute to the charging and discharging reactions. In FIG. 5, for easier understanding of a range in which the covered part 21AX (the positive electrode active material layer 21B) is provided, the range in which the covered part 21AX is provided, i.e., a boundary between the opposed part 22BX and the non-opposed part 22BY, is indicated by a dashed line.

The negative electrode active material layer 22B is entirely provided on each of the two opposed surfaces of the negative electrode current collector 22A, whereas the positive electrode active material layer 21B is provided only on a portion (the covered part 21AX) of each of the two opposed surfaces of the positive electrode current collector 21A, in order to prevent lithium extracted from the positive electrode active material layer 21B at the time of charging from precipitating on the surface of the negative electrode 22.

Here, in a case of examining each of the weight ratio MA and the weight sum MB ex post facto after completion of the secondary battery, it is preferable to use the non-opposed part 22BY of the negative electrode active material layer 22B. A reason for this is that the non-opposed part 22BY hardly contributes to the charging and discharging reactions. At the non-opposed part 22BY, the mixture ratio between lithium fluoride and lithium ethylene dicarbonate and the mixture amount of lithium fluoride and lithium ethylene dicarbonate are each maintained in the state at the time of forming the negative electrode 22 without being influenced by the charging and discharging reactions. Accordingly, it is possible to examine each of the weight ratio MA and the weight sum MB in a highly stable and reproducible manner even in a case where the secondary battery has been used.

As illustrated in FIG. 3, the separator 23 is an insulating porous film interposed between the positive electrode 21 and the negative electrode 22 and allows a lithium ion to pass therethrough while preventing contact (a short circuit) between the positive electrode 21 and the negative electrode 22. The separator 23 includes a polymer compound such as polyethylene.

The electrolytic solution is a liquid electrolyte. The positive electrode 21, the negative electrode 22, and the separator 23 are each impregnated with the electrolytic solution. The electrolytic solution includes a solvent and an electrolyte salt.

Here, the solvent includes any one or more of non-aqueous solvents (organic solvents), and the electrolytic solution including the non-aqueous solvent(s) is what is called a non-aqueous electrolytic solution. The non-aqueous solvent includes, for example, an ester or an ether, more specifically, a carbonic-acid-ester-based compound, a carboxylic-acid-ester-based compound, or a lactone-based compound, for example. A reason for this is that a dissociation property of the electrolyte salt improves and ion mobility also improves.

The carbonic-acid-ester-based compound is, for example, a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is a chain carboxylic acid ester, for example. Specific examples of the chain carboxylic acid ester include ethyl acetate, ethyl propionate, propyl propionate, and ethyl trimethylacetate.

The lactone-based compound is a lactone, for example. Specific examples of the lactone include γ-butyrolactone and γ-valerolactone.

Note that the ether may be 1,2-dimethoxyethane, tetrahydrofuran, 1,3-dioxolane, or 1,4-dioxane, for example.

The electrolyte salt includes any one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). A reason for this is that a high battery capacity is obtainable.

A content of the electrolyte salt is not particularly limited and is specifically within a range from 0.3 mol/kg to 3.0 mol/kg both inclusive with respect to the solvent. A reason for this is that high ion conductivity is obtainable.

Note that the electrolytic solution may further include any one or more of additives. The additives are not particularly limited in kind, and specific examples thereof include an unsaturated cyclic carbonic acid ester, a fluorinated cyclic carbonic acid ester, a sulfonic acid ester, a phosphoric acid ester, an acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

As illustrated in FIG. 4, the positive electrode terminal 31 is electrically coupled to the positive electrode 21, and more specifically, is electrically coupled to the positive electrode current collector 21A. Because the positive electrode 21 and the negative electrode 22 are alternately stacked on each other with the separator 23 interposed therebetween in the battery device 20 as described above, the battery device 20 includes multiple positive electrodes 21. Thus, the secondary battery includes the multiple positive electrode terminals 31.

The positive electrode terminal 31 includes an electrically conductive material such as a metal material, and the electrically conductive material is not particularly limited in kind. Specifically, the positive electrode terminal 31 includes a material similar to the material included in the positive electrode current collector 21A.

Here, because the protruding part of the positive electrode current collector 21A serves as the positive electrode terminal 31 as described above, the positive electrode terminal 31 is physically integrated with the positive electrode current collector 21A. A reason for this is that this reduces coupling resistance between the positive electrode current collector 21A and the positive electrode terminal 31, thus reducing electric resistance of the entire secondary battery.

The multiple positive electrode terminals 31 are joined to each other by a joining method such as a welding method as will be described later, and thus form a single joint part 31Z having a lead shape as illustrated in FIG. 2.

As illustrated in FIG. 5, the negative electrode terminal 32 is electrically coupled to the negative electrode 22, and more specifically, is electrically coupled to the negative electrode current collector 22A. Because the positive electrode 21 and the negative electrode 22 are alternately stacked on each other with the separator 23 interposed therebetween in the battery device 20 as described above, the battery device 20 includes multiple negative electrodes 22. Thus, the secondary battery includes the multiple negative electrode terminals 32.

The negative electrode terminal 32 includes an electrically conductive material such as a metal material, and the electrically conductive material is not particularly limited in kind. Specifically, the negative electrode terminal 32 includes a material similar to the material included in the negative electrode current collector 22A.

Here, because the protruding part of the negative electrode current collector 22A serves as the negative electrode terminal 32 as described above, the negative electrode terminal 32 is physically integrated with the negative electrode current collector 22A. A reason for this is that this reduces coupling resistance between the negative electrode current collector 22A and the negative electrode terminal 32, thus reducing the electric resistance of the entire secondary battery.

The multiple negative electrode terminals 32 are joined to each other by a joining method such as a welding method as will be described later, and thus form a single joint part 32Z having a lead shape as illustrated in FIG. 2.

As illustrated in FIG. 2, the positive electrode lead 41 is coupled to the joint part 31Z, and is led from an inside to an outside of the outer package film 10. The positive electrode lead 41 includes an electrically conductive material such as a metal material. Specifically, the positive electrode lead 41 includes a material similar to the material included in the positive electrode current collector 21A. The positive electrode lead 41 is not particularly limited in shape, and specifically has any of shapes including, without limitation, a thin plate shape and a meshed shape.

As illustrated in FIG. 2, the negative electrode lead 42 is coupled to the joint part 32Z, and is led from the inside to the outside of the outer package film 10. The negative electrode lead 42 includes an electrically conductive material such as a metal material. Specifically, the negative electrode lead 42 includes a material similar to the material included in the negative electrode current collector 22A. Note that a direction in which the negative electrode lead 42 is led is similar to the direction in which the positive electrode lead 41 is led. Details of a shape of the negative electrode lead 42 are similar to those of the shape of the positive electrode lead 41.

The sealing film 51 is interposed between the outer package film 10 and the positive electrode lead 41. The sealing film 52 is interposed between the outer package film 10 and the negative electrode lead 42. Note that the sealing film 51, the sealing film 52, or both may be omitted.

The sealing film 51 is a sealing member that prevents entry of, for example, outside air into the outer package film 10. The sealing film 51 includes a polymer compound such as a polyolefin that has adherence to the positive electrode lead 41. Specific examples of the polymer compound include polypropylene.

A configuration of the sealing film 52 is similar to that of the sealing film 51 except that the sealing film 52 is a sealing member that has adherence to the negative electrode lead 42. That is, the sealing film 52 includes a polymer compound such as a polyolefin that has adherence to the negative electrode lead 42.

Upon charging the secondary battery, in the battery device 20, lithium is extracted from the positive electrode 21, and the extracted lithium is inserted into the negative electrode 22 via the electrolytic solution. Upon discharging the secondary battery, in the battery device 20, lithium is extracted from the negative electrode 22, and the extracted lithium is inserted into the positive electrode 21 via the electrolytic solution. Upon charging and discharging, lithium is inserted and extracted in an ionic state.

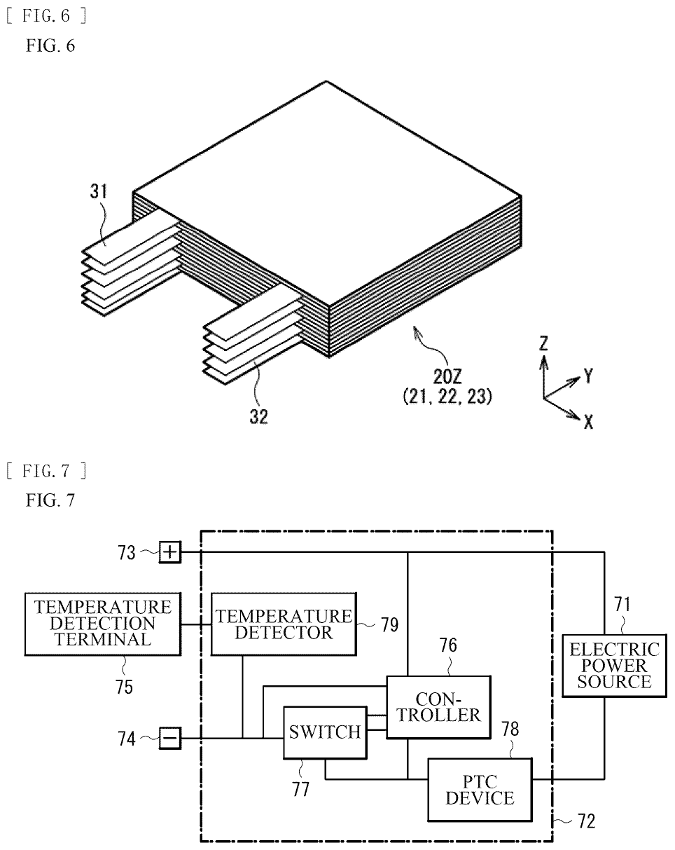

FIG. 6 illustrates a perspective configuration corresponding to FIG. 2 to describe a method of manufacturing the secondary battery. Note that FIG. 6 illustrates, instead of the battery device 20, a stacked body 20Z to be used to fabricate the battery device 20. Details of the stacked body 20Z will be described later.

In a case of manufacturing the secondary battery, the positive electrode 21 and the negative electrode 22 are each fabricated, and the electrolytic solution is prepared, following which the secondary battery is assembled using the positive electrode 21, the negative electrode 22, and the electrolytic solution, and a stabilization process of the secondary battery is performed, according to an example procedure to be described below.

First, a mixture (a positive electrode mixture) in which the positive electrode active material, the positive electrode binder, and the positive electrode conductor are mixed with each other is put into a solvent to thereby prepare a positive electrode mixture slurry in paste form. The solvent may be an aqueous solvent, or may be an organic solvent. Thereafter, the positive electrode mixture slurry is applied on the two opposed surfaces (excluding the positive electrode terminal 31) of the positive electrode current collector 21A with which the positive electrode terminal 31 is integrated, to thereby form the positive electrode active material layers 21B. Lastly, the positive electrode active material layers 21B are compression-molded by means of, for example, a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode 22 is formed by a procedure similar to the fabrication procedure of the negative electrode 100 described above. Specifically, first, a mixture (a negative electrode mixture) in which the negative electrode active material, lithium fluoride, lithium ethylene carbonate, and the negative electrode binder are mixed with each other is put into a solvent to thereby prepare a negative electrode mixture slurry in paste form. Thereafter, the negative electrode mixture slurry is applied on the two opposed surfaces (excluding the negative electrode terminal 32) of the negative electrode current collector 22A with which the negative electrode terminal 32 is integrated, to thereby form the negative electrode active material layers 22B. Lastly, the negative electrode active material layers 22B are compression-molded. The negative electrode active material layers 22B are thus formed on the two respective opposed surfaces of the negative electrode current collector 22A. As a result, the negative electrode 22 is fabricated.

The electrolyte salt is put into a solvent. The electrolyte salt is thereby dispersed or dissolved in the solvent. As a result, the electrolytic solution is prepared.

First, the positive electrodes 21 and the negative electrodes 22 are alternately stacked on each other with the separators 23 each interposed between corresponding one of the positive electrodes 21 and corresponding one of the negative electrodes 22 to thereby fabricate the stacked body 20Z, as illustrated in FIG. 6. The stacked body 20Z has a configuration similar to that of the battery device 20 except that the positive electrodes 21, the negative electrodes 22, and the separators 23 are each not impregnated with the electrolytic solution.

Thereafter, the multiple positive electrode terminals 31 are joined to each other by a joining method such as a welding method to thereby form the joint part 31Z, following which the positive electrode lead 41 is coupled to the joint part 31Z by a joining method such as a welding method. In addition, the multiple negative electrode terminals 32 are joined to each other by a joining method such as a welding method to thereby form the joint part 32Z, following which the negative electrode lead 42 is coupled to the joint part 32Z by a joining method such as a welding method.

Thereafter, the stacked body 20Z is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the stacked body 20Z to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by a bonding method such as a thermal-fusion-bonding method. In this case, the sealing film 51 is interposed between the outer package film 10 and the positive electrode lead 41, and the sealing film 52 is interposed between the outer package film 10 and the negative electrode lead 42.

The stacked body 20Z is thereby impregnated with the electrolytic solution, and the battery device 20, i.e., the stacked electrode body, is thus fabricated. Accordingly, the battery device 20 is sealed in the outer package film 10 having the pouch shape. As a result, the secondary battery is assembled.

The assembled secondary battery is charged and discharged. Various conditions including, for example, an environment temperature, the number of times of charging and discharging (the number of cycles), and charging and discharging conditions may be set as desired. As a result, a film is formed on the surface of each of the positive electrode 21 and the negative electrode 22, which electrochemically stabilizes a state of the secondary battery. As a result, the secondary battery is completed.

In the stabilization process of the secondary battery, a film having multiple fine pores is formed and the film is densified, because the negative electrode active material layer 22B of the negative electrode 22 includes lithium fluoride and lithium ethylene dicarbonate and the respective conditions described above are satisfied regarding the weight ratio MA and the weight sum MB.

The secondary battery includes the negative electrode 22, and the negative electrode 22 has a configuration similar to that of the negative electrode 100. Accordingly, it is possible to achieve a superior battery characteristic for the reason described above.

In particular, the secondary battery may include a lithium-ion secondary battery. This makes it possible to obtain a sufficient battery capacity stably through insertion and extraction of lithium. Accordingly, it is possible to achieve higher effects.

The configuration of the secondary battery described above is appropriately modifiable including as described below according to an embodiment. Note that any two or more of the following series of modifications may be combined with each other.

In FIG. 4, the protruding part of the positive electrode current collector 21A also serves as the positive electrode terminal 31, and the positive electrode terminal 31 is thus physically integrated with the positive electrode current collector 21A. However, the positive electrode terminal 31 may be physically separated from the positive electrode current collector 21A, and may thus be separated from the positive electrode current collector 21A. In this case, the positive electrode terminal 31 may be coupled to the positive electrode current collector 21A by a joining method such as a welding method.

In this case also, the positive electrode terminal 31 is electrically coupled to the positive electrode 21, and similar effects are therefore obtainable. Note that it is preferable that the positive electrode terminal 31 be physically integrated with the positive electrode current collector 21A in order to reduce the coupling resistance and accordingly reduce the electric resistance of the entire secondary battery.

Similarly, in FIG. 5, the protruding part of the negative electrode current collector 22A also serves as the negative electrode terminal 32, and the negative electrode terminal 32 is thus physically integrated with the negative electrode current collector 22A. However, the negative electrode terminal 32 may be physically separated from the negative electrode current collector 22A, and may thus be separated from the negative electrode current collector 22A. In this case, the negative electrode terminal 32 may be coupled to the negative electrode current collector 22A by a joining method such as a welding method.

In this case also, the negative electrode terminal 32 is electrically coupled to the negative electrode 22, and similar effects are therefore obtainable. Note that it is preferable that the negative electrode terminal 32 be physically integrated with the negative electrode current collector 22A in order to reduce the coupling resistance and accordingly reduce the electric resistance of the entire secondary battery.

In FIG. 2, the battery device 20 that is the stacked electrode body is used. However, although not specifically illustrated here, a battery device that is a wound electrode body may be used. In this case, the positive electrode 21 has a band-shaped structure, the positive electrode terminal 31 is electrically coupled to the positive electrode current collector 21A, the negative electrode 22 has a band-shaped structure, and the negative electrode terminal 32 is electrically coupled to the negative electrode current collector 22A. Thus, the positive electrode 21 and the negative electrode 22 are opposed to each other with the separator 23 interposed therebetween and are wound.

In this case also, the secondary battery is chargeable and dischargeable using the battery device 20, and similar effects are therefore obtainable.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. A reason for this is that adherence of the separator to each of the positive electrode 21 and the negative electrode 22 improves to suppress misalignment (winding displacement) of the battery device 20. This suppresses swelling of the secondary battery even if a side reaction such as the decomposition reaction of the electrolytic solution occurs. The polymer compound layer includes a polymer compound such as polyvinylidene difluoride. A reason for this is that superior physical strength and superior electrochemical stability are obtainable.

Note that the porous film, the polymer compound layer, or both may each include any one or more kinds of insulating particles. A reason for this is that the insulating particles promote heat dissipation upon heat generation by the secondary battery, thus improving safety or heat resistance of the secondary battery. The insulating particles include any one or more of insulating materials including, without limitation, an inorganic material and a resin material. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, insulating particles may be added to the precursor solution on an as-needed basis.

When the separator of the stacked type is used also, a lithium ion is movable between the positive electrode 21 and the negative electrode 22, and similar effects are therefore obtainable. In this case, in particular, the secondary battery improves in safety, as described above. Accordingly, it is possible to achieve higher effects.

The electrolytic solution, which is a liquid electrolyte, is used. However, although not specifically illustrated here, an electrolyte layer, which is a gel electrolyte, may be used.

In the battery device 20 including the electrolyte layer, the positive electrode 21 and the negative electrode 22 are alternately stacked on each other with the separator 23 and the electrolyte layer interposed therebetween. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

When the electrolyte layer is used also, a lithium ion is movable between the positive electrode 21 and the negative electrode 22 via the electrolyte layer, and similar effects are therefore obtainable. In this case, in particular, the leakage of the electrolytic solution is prevented, as described above. Accordingly, it is possible to achieve higher effects.

Applications (application examples) of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a single battery, or may each include an assembled battery. The electric vehicle is a vehicle that travels with the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example, home appliances.

An application example of the secondary battery will now be described in detail. The configuration of the application example described below is merely an example, and is appropriately modifiable.

FIG. 7 illustrates a block configuration of a battery pack. The battery pack described here is a battery pack (what is called a soft pack) including one secondary battery, and is to be mounted on, for example, electronic equipment typified by a smartphone.

As illustrated in FIG. 7, the battery pack includes an electric power source 71 and a circuit board 72. The circuit board 72 is coupled to the electric power source 71, and includes a positive electrode terminal 73, a negative electrode terminal 74, and a temperature detection terminal 75.

The electric power source 71 includes one secondary battery. The secondary battery has a positive electrode lead coupled to the positive electrode terminal 73 and a negative electrode lead coupled to the negative electrode terminal 74. The electric power source 71 is couplable to outside via the positive electrode terminal 73 and the negative electrode terminal 74, and is thus chargeable and dischargeable. The circuit board 72 includes a controller 76, a switch 77, a thermosensitive resistive device (a PTC device) 78, and a temperature detector 79. However, the PTC device 78 may be omitted.

The controller 76 includes, for example, a central processing unit (CPU) and a memory, and controls an overall operation of the battery pack. The controller 76 detects and controls a use state of the electric power source 71 on an as-needed basis.

If a voltage of the electric power source 71 (the secondary battery) reaches an overcharge detection voltage or an overdischarge detection voltage, the controller 76 turns off the switch 77. This prevents a charging current from flowing into a current path of the electric power source 71. The overcharge detection voltage is not particularly limited, and is specifically 4.20 V±0.05 V. The overdischarge detection voltage is not particularly limited, and is specifically 2.40 V±0.1 V.

The switch 77 includes, for example, a charge control switch, a discharge control switch, a charging diode, and a discharging diode. The switch 77 performs switching between coupling and decoupling between the electric power source 71 and external equipment in accordance with an instruction from the controller 76. The switch 77 includes, for example, a metal-oxide-semiconductor field-effect transistor (MOSFET). The charging and discharging currents are detected based on an ON-resistance of the switch 77.

The temperature detector 79 includes a temperature detection device such as a thermistor. The temperature detector 79 measures a temperature of the electric power source 71 through the temperature detection terminal 75, and outputs a result of the temperature measurement to the controller 76. The result of the temperature measurement to be obtained by the temperature detector 79 is used, for example, when the controller 76 performs charge and discharge control upon abnormal heat generation or when the controller 76 performs a correction process upon calculating a remaining capacity.

### EXAMPLES

A description is given of Examples of the present technology according to an embodiment.

### Examples 1 to 8 and Comparative Examples 1 to 5

Secondary batteries were manufactured, following which the secondary batteries were each evaluated for a battery characteristic as described below.

### [Manufacturing of Secondary Battery]

The secondary batteries (the lithium-ion secondary batteries of the laminated-film type) illustrated in FIGS. 2 to 5 were manufactured in accordance with the following procedure.

### (Fabrication of Positive Electrode)

First, 94 parts by mass of the positive electrode active material (LiCoO₂ as the lithium-containing compound (an oxide)), 3 parts by mass of the positive electrode binder (polyvinylidene difluoride), and 3 parts by mass of the positive electrode conductor (Ketjen black, i.e., amorphous carbon powder) were mixed with each other to thereby obtain a positive electrode mixture. Thereafter, the positive electrode mixture was put into a solvent (N-methyl-2-pyrrolidone as the organic solvent), following which the organic solvent was stirred to thereby prepare a positive electrode mixture slurry in paste form. Thereafter, the positive electrode mixture slurry was applied on the two opposed surfaces (excluding the positive electrode terminal 31) of the positive electrode current collector 21A (an aluminum foil having a thickness of 20 μm) with which the positive electrode terminal 31 was integrated, by means of a coating apparatus, following which the applied positive electrode mixture slurry was dried to thereby form the positive electrode active material layers 21B. Lastly, the positive electrode active material layers 21B were compression-molded by means of a roll pressing machine. The positive electrode 21 was thus fabricated.

### (Fabrication of Negative Electrode)

First, 70 parts by mass of a negative electrode active material (artificial graphite as the carbon material), 25 parts by mass of a negative electrode active material (SiOₓ as the silicon-containing material), 3 parts by mass of the negative electrode binder (a styrene-butadiene rubber), and 2 parts by mass of a thickener (carboxymethyl cellulose) were mixed with each other to thereby form a negative electrode mixture. Thereafter, the negative electrode mixture was put into a solvent (water as the aqueous solvent), following which the organic solvent was stirred to thereby prepare a negative electrode mixture slurry in paste form.

Thereafter, lithium fluoride and lithium ethylene dicarbonate were added to the negative electrode mixture slurry, and the negative electrode mixture slurry was stirred. In this case, the amount of lithium fluoride added and the amount of lithium ethylene dicarbonate added were adjusted to allow the weight ratio MA and the weight sum MB (wt %) to have respective values listed in Table 1.

In a case of synthesizing lithium ethylene dicarbonate, an organic solvent (ethylene carbonate) and a tetrahydrofuran solution of lithium naphthalenide were mixed with each other, following which the mixture was allowed to stand (for a standing time of 1 day). This caused ethylene carbonate and lithium naphthalenide to react with each other, and lithium ethylene dicarbonate was thus synthesized.

Thereafter, the negative electrode mixture slurry was applied on the two opposed surfaces (excluding the negative electrode terminal 32) of the negative electrode current collector 22A (a copper foil having a thickness of 15 μm) with which the negative electrode terminal 32 was integrated, by means of a coating apparatus, following which the applied negative electrode mixture slurry was dried to thereby form the negative electrode active material layers 22B. Lastly, the negative electrode active material layers 22B were compression-molded by means of a roll pressing machine. The negative electrode 22 was thus fabricated.

Note that, for comparison, the negative electrode 22 was fabricated by a similar procedure except that neither lithium fluoride nor lithium ethylene dicarbonate was used, as indicated in Table 1.

### (Preparation of Electrolytic Solution)

First, the electrolyte salt (LiPF₆) was put into the solvent, following which the solvent was stirred. Used as the solvent were ethylene carbonate and propylene carbonate each as the cyclic carbonic acid ester, dimethyl carbonate and ethyl methyl carbonate each as the chain carbonic acid ester, and monofluoroethylene carbonate as the fluorinated cyclic carbonic acid ester. A composition of the solvent, i.e., a mass ratio between ethylene carbonate, propylene carbonate, dimethyl carbonate, ethyl methyl carbonate, and monofluoroethylene carbonate, was set to 29:5:60:5:1. The content of the electrolyte salt was set to 1.2 mol/kg with respect to the solvent.

### (Assembly of Secondary Battery)

First, the positive electrodes 21 and the negative electrodes 22 were stacked on each other with the separators 23 (fine porous polyethylene films each having a thickness of 15 μm) each interposed between corresponding one of the positive electrodes 21 and corresponding one of the negative electrodes 22, to thereby fabricate the stacked body 20Z.

Thereafter, the multiple positive electrode terminals 31 were welded to each other to thereby form the joint part 31Z, following which the positive electrode lead 41 (an aluminum foil) was welded to the joint part 31Z. In addition, the multiple negative electrode terminals 32 were welded to each other to thereby form the joint part 32Z, following which the negative electrode lead 42 (a copper foil) was welded to the joint part 32Z.

Thereafter, the outer package film 10 (the fusion-bonding layer/the metal layer/the surface protective layer) was so folded as to sandwich the stacked body 20Z placed in the depression part 10U. Thereafter, the outer edge parts of two sides of the fusion-bonding layer were thermal-fusion-bonded to each other to thereby allow the stacked body 20Z to be contained inside the outer package film 10 having the pouch shape. As the outer package film 10, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from the inner side.

Lastly, the electrolytic solution was injected into the outer package film 10 having the pouch shape, following which the outer edge parts of the remaining one side of the fusion-bonding layer were thermal-fusion-bonded to each other in a reduced-pressure environment. In this case, the sealing film 51 (a polypropylene film having a thickness of 5 μm) was interposed between the outer package film 10 and the positive electrode lead 41, and the sealing film 52 (a polypropylene film having a thickness of 5 μm) was interposed between the outer package film 10 and the negative electrode lead 42. The stacked body 20Z was thereby impregnated with the electrolytic solution, and the battery device 20, i.e., the stacked electrode body, was thus fabricated.

Accordingly, the battery device 20 was sealed in the outer package film 10. As a result, the secondary battery was assembled.

### (Stabilization of Secondary Battery)

The secondary battery was charged and discharged for one cycle in an ambient temperature environment (at a temperature of 25° C.). Upon charging, the secondary battery was charged with a constant current of 0.1 C until a voltage reached 4.2 V, and was thereafter charged with a constant voltage of that value, 4.2 V, until a current reached 0.05 C. Upon discharging, the secondary battery was discharged with a constant current of 0.1 C until the voltage reached 2.5 V. Note that 0.1 C was a value of a current that caused a battery capacity (a theoretical capacity) to be completely discharged in 10 hours, and 0.05 C was a value of a current that caused the battery capacity to be completely discharged in 20 hours.

A film was thus formed on the surface of each of the positive electrode 21 and the negative electrode 22, and the state of the secondary battery was therefore electrochemically stabilized. As a result, the secondary battery of the laminated-film type was completed.

### [Evaluation of Battery Characteristic]

Evaluation of a cyclability characteristic as the battery characteristic revealed the results presented in Table 1.

In a case of evaluating the cyclability characteristic, first, the secondary battery was charged and discharged in an ambient temperature environment (at a temperature of 25° C.) to thereby measure a discharge capacity (a first-cycle discharge capacity).

Thereafter, the secondary battery was repeatedly charged and discharged in the same environment until the total number of cycles reached 300 to thereby measure the discharge capacity (a 300th-cycle discharge capacity).

Lastly, a capacity retention rate as an index for evaluating the cyclability characteristic was calculated based on the following calculation expression: capacity retention rate (%)=(300th-cycle discharge capacity/first-cycle discharge capacity)×100.

Upon charging, the secondary battery was charged with a constant current with a current density of 3 mA/cm² until a voltage reached 4.45 V, and was thereafter charged with a constant voltage of that value, 4.45 V, until the current density reached 0.7 mA/cm². Upon discharging, the secondary battery was discharged with a constant current with a current density of 100 mA/cm² until the voltage reached 3.0 V.

TABLE 1

| | Weight | Weight | Capacity |
|---|---|---|---|
| | ratio MA | sum MB | retention rate |
| | (—) | (wt %) | (%) |
| Comparative example 1 | 0.005 | 0.2 | 49 |
| Example 1 | 0.01 | 0.2 | 81 |
| Example 2 | 0.02 | 0.2 | 87 |
| Example 3 | 0.08 | 0.2 | 80 |
| Example 4 | 0.16 | 0.2 | 78 |
| Example 5 | 0.2 | 0.2 | 72 |
| Comparative example 2 | 0.25 | 0.2 | 59 |
| Comparative example 3 | 0.02 | 0.1 | 69 |
| Example 6 | 0.02 | 1.0 | 85 |
| Example 7 | 0.02 | 1.5 | 84 |
| Example 8 | 0.02 | 2.0 | 74 |
| Comparative example 4 | 0.02 | 2.2 | 30 |
| Comparative example 5 | — | — | 31 |

As indicated in Table 1, the capacity retention rate varied greatly depending on the configuration of the negative electrode 22.

In the following, the capacity retention rate when the negative electrode active material layer 22B of the negative electrode 22 included neither lithium fluoride nor lithium ethylene dicarbonate (Comparative example 5) was set as a comparison reference.

Specifically, when the negative electrode active material layer 22B of the negative electrode 22 included lithium fluoride and lithium ethylene dicarbonate (Examples 1 to 8 and Comparative examples 1 to 4), the capacity retention rate varied depending on each of the weight ratio MA and the weight sum MB.

That is, when the appropriate conditions that the weight ratio MA was within the range from 0.01 to 0.2 both inclusive and that the weight sum MB was within the range from 0.2 wt % to 2.0 wt % both inclusive were not satisfied (Comparative examples 1 to 4), the capacity retention rate increased in some cases, but the capacity retention rate did not increase sufficiently.

In contrast, when the respective appropriate conditions described above were satisfied regarding the weight ratios MA and MB (Examples 1 to 8), the capacity retention rate markedly increased.

In this case, in particular, the capacity retention rate increased sufficiently, because the negative electrode active material included the silicon-containing material, and more specifically, the negative electrode active material included the carbon material and the silicon-containing material.

Based upon the results presented in Table 1, when: the negative electrode active material layer 22B of the negative electrode 22 included the negative electrode active material, lithium fluoride, and lithium ethylene dicarbonate; the weight ratio MA was within the range from 0.01 to 0.2 both inclusive; and the weight sum MB was within the range from 0.2 wt % to 2.0 wt % both inclusive, a high capacity retention rate was obtained. This improved the cyclability characteristic of the secondary battery. Accordingly, it was possible to achieve a superior battery characteristic.

Although the present technology has been described above with reference to some embodiments and Examples, the configuration of the present technology is not limited to those described with reference to the embodiments and Examples above, and is therefore modifiable in a variety of ways.

Specifically, the description has been given of the case where the battery device has a device structure of the stacked type (the stacked electrode body) or the wound type (the wound electrode body). However, the device structure of the battery device is not particularly limited, and may be, for example, of a zigzag folded type. In the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode including a negative electrode active material layer; and
an electrolytic solution, wherein
the negative electrode active material layer includes
a negative electrode active material,
lithium fluoride (LiF), and
lithium ethylene dicarbonate (Li—OC(═O)O—C₂H₄—OC(═O)O—Li),
a weight ratio represented by Expression (1) is greater than or equal to 0.01 and less than or equal to 0.2, and
a weight sum represented by Expression (2) is greater than or equal to 0.2 weight percent and less than or equal to 2.0 weight percent,
$$MA = M 2 / M 1 \qquad ( 1 )$$
where
MA is the weight ratio,
M1 is a ratio (weight percent) of a weight of lithium fluoride to a weight of the negative electrode active material, and
M2 is a ratio (weight percent) of a weight of lithium ethylene dicarbonate to the weight of the negative electrode active material,
$$MB = M 1 + M 2 \qquad ( 2 )$$
where
MB is the weight sum (weight percent),
M1 is the ratio (weight percent) of the weight of lithium fluoride to the weight of the negative electrode active material, and
M2 is the ratio (weight percent) of the weight of lithium ethylene dicarbonate to the weight of the negative electrode active material.

2. The secondary battery according to claim 1, wherein the negative electrode active material includes a silicon-containing material.

3. The secondary battery according to claim 2, wherein the negative electrode active material further includes a carbon material.

4. The secondary battery according to claim 1, wherein the secondary battery comprises a lithium-ion secondary battery.

5. A negative electrode for a secondary battery, the negative electrode comprising:
a negative electrode active material layer, wherein
the negative electrode active material layer includes
a negative electrode active material,
lithium fluoride, and
lithium ethylene dicarbonate,
a weight ratio represented by Expression (1) is greater than or equal to 0.01 and less than or equal to 0.2, and
a weight sum represented by Expression (2) is greater than or equal to 0.2 weight percent and less than or equal to 2.0 weight percent,
$$MA = M 2 / M 1 \qquad ( 1 )$$
where
MA is the weight ratio,
M1 is a ratio (weight percent) of a weight of lithium fluoride to a weight of the negative electrode active material, and
M2 is a ratio (weight percent) of a weight of lithium ethylene dicarbonate to the weight of the negative electrode active material,
$$MB = M 1 + M 2 \qquad ( 2 )$$
where
MB is the weight sum (weight percent),
M1 is the ratio (weight percent) of the weight of lithium fluoride to the weight of the negative electrode active material, and
M2 is the ratio (weight percent) of the weight of lithium ethylene dicarbonate to the weight of the negative electrode active material.
